(19) United States
(12) Patent Application Publication
(10) Pub. No.: US 2026/0189906 A1
(43) Pub. Date: Jul. 2, 2026

(54) WIRELESS NETWORK SYSTEM AND METHOD FOR SHARING CONNECTION AUTHENTICATION INFORMATION THEREOF

(71) Applicant: SENAO NETWORKS, INC., TAOYUAN (TW)

(72) Inventors: Chih Heng LEE, TAOYUAN (TW); Yu Lin TSAI, TAOYUAN (TW); Chun Hsien HO, TAOYUAN (TW)

(21) Appl. No.: 19/189,475

(22) Filed: Apr. 25, 2025

(30) Foreign Application Priority Data
Jan. 2, 2025 (TW) 114100060

(51) Int. Cl. H04W 12/06; H04W 76/10; H04W 76/40

(52) U.S. Cl. CPC H04W 12/06; H04W 76/10; H04W 76/40

(57) ABSTRACT

In a wireless network system, when a request for connection of a mobile device is successfully authenticated by a wireless access point, the wireless access point provides the connection authentication information of the mobile device to another wireless access point, so that both of the wireless access points can store the connection authentication information collaboratively.

### CROSS-REFERENCES TO RELATED APPLICATIONS

This application claims priority to Taiwan Patent Application No. 114100060 filed on Jan. 2, 2025, which is hereby incorporated by reference in its entirety.

### BACKGROUND OF THE INVENTION

### Field of the Invention

The present invention relates to a wireless network system and a method for sharing information thereof, and more specifically, relates to a wireless network system and a method for sharing connection authentication information thereof.

### Descriptions of the Related Art

In the traditional wireless network system, whenever a mobile device moves to a new wireless access point (WAP), it is necessary for the mobile device to conduct a connection authentication procedure with the wireless access point, and the mobile device can establish a connection with the wireless access point only after a request for connection of the mobile device is successfully authenticated by the wireless access point. However, such a connection authentication procedure will delay the establishment of connection between the mobile device and the wireless access point, and may even lead to the suspension of the network service that the mobile device originally accepted. In scenarios requiring stable connection, such as corporate networks, smart homes, or public hotspots, the negative impact of such connection authentication procedure is particularly serious.

Therefore, a technical problem that needs to be solved urgently in the art is to improve the delay in establishing connection with new wireless access points for a mobile device due to the complicated (repeated) connection authentication procedures when the mobile device roams between wireless access points.

### SUMMARY OF THE INVENTION

In order to at least solve the above technical problems, the present invention provides a wireless network system. The wireless network system may comprise a first wireless access point and a second wireless access point communicatively connected to the first wireless access point. The second wireless access point is configured to: perform connection authentication for a mobile device when the mobile device requests for a connection; and provide connection authentication information of the mobile device to the first wireless access point after completing the connection authentication for the mobile device, so that the first wireless access point and the second wireless access point collectively store the connection authentication information of the mobile device.

In order to at least solve the above technical problems, the present invention further provides a method for sharing connection authentication information. The method for sharing connection authentication information is executed by a wireless network system, and the wireless network system comprises a first wireless access point and a second wireless access point communicatively connected to the first wireless access point. The method for sharing connection authentication information may comprise the following steps: performing connection authentication for a mobile device by the second wireless access point when the mobile device requests for a connection to the second wireless access point; and providing the connection authentication information of the mobile device from the second wireless access point to the first wireless access point after the second wireless access point completes the connection authentication for the mobile device, so that the first wireless access point and the second wireless access point collectively store the connection authentication information of the mobile device.

As described above, in the present invention, when a mobile device requests for a connection to the second wireless access point, the second wireless access point performs connection authentication for the mobile device; and the second wireless access point subsequently provides the connection authentication information of the mobile device to the first wireless access point after the request for connection of the mobile device is successfully authenticated, so that the first wireless access point and the second wireless access point collectively store the authentication information. Accordingly, when the mobile device roams from the second wireless access point to the first wireless access point, it is unnecessary to perform the traditional connection authentication procedure again for the mobile device because the first wireless access point has stored the connection authentication information of the mobile device. In other words, the present invention effectively solves the problem of delay in establishing connection with new wireless access points for a mobile device due to the complicated (repeated) connection authentication procedures when the mobile device roams between wireless access points.

The above description is not intended to limit the present invention but merely aims to provide the basic conception of the present invention including the technical problems that can be solved by the present invention, the technical means that can be adopted by the present invention and the technical effects that can be achieved by the present invention. According to the attached drawings and the contents described in the following embodiments, those of ordinary skill in the art can further understand various embodiments of the present invention.

### BRIEF DESCRIPTION OF THE DRAWINGS

FIG. 1 illustrates a schematic view of a wireless network system according to the present invention.

FIG. 2 illustrates a schematic view for how the wireless network system shown in FIG. 1 implements the sharing of connection authentication information.

FIG. 3 illustrates a schematic view of another wireless network system according to the present invention.

FIG. 4 illustrates a schematic view for how the wireless network system shown in FIG. 3 implements the sharing of connection authentication information.

FIG. 5 illustrates a schematic view of yet another wireless network system according to the present invention.

FIG. 6 illustrates a schematic view for how the wireless network system shown in FIG. 5 implements the sharing of connection authentication information.

FIG. 7 illustrates a schematic view of a method for sharing connection authentication information according to the present invention.

### DESCRIPTION OF THE PREFERRED EMBODIMENT

The following embodiments are not intended to limit the claimed invention to a specific environment, application, structure, process, or situation. The attached drawings are only used to assist in explaining the embodiments disclosed below, and are not intended to limit the scope claimed in the present invention. For example, in the attached drawings, elements unrelated to the claimed invention are omitted from depiction. For example, in the attached drawings, dimensions of and dimensional scales among individual elements are only provided as exemplary examples, and are not intended to limit the claimed invention. The same element symbols in the following description may refer to the same elements, unless otherwise specified.

Terms such as “a” or “an” are not used to limit the quantity, and should be regarded as an embodiment that includes a plurality of the same referents. Terms such as “comprising”, “including” and “having” are used to illustrate the existence of features, integers, steps, operations, elements, components and/or groups stated after the terms, but do not exclude the presence or addition of one or more other additional features, integers, steps, operations, elements, components and/or groups thereof. The term “and/or” is used to represent any one or various permutations and combinations of one or more associated items listed. Terms such as “first”, “second” and “third” used to describe the features, integers, steps, operations, elements, components and/or groups stated after the terms are not intended to limit the order of these described objects, but only used to distinguish these described objects.

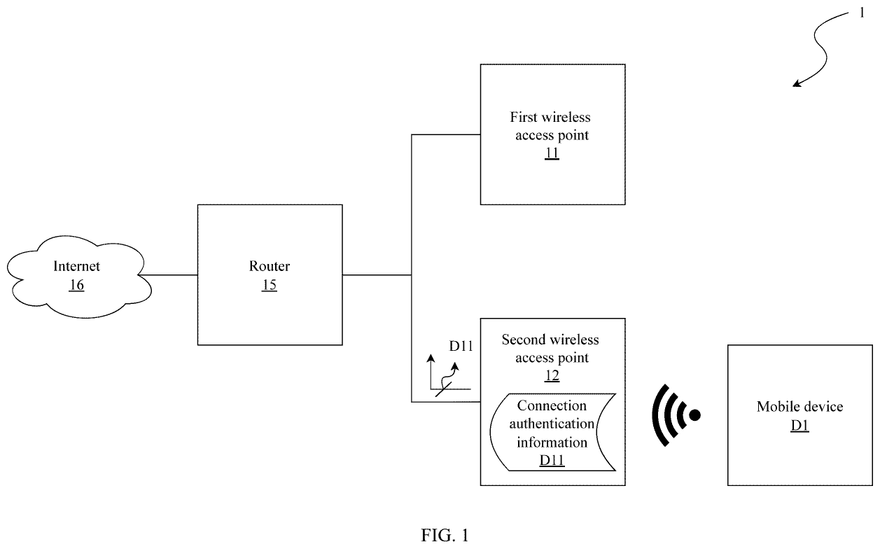

FIG. 1 illustrates a schematic view of a wireless network system according to the present invention. Referring to FIG. 1, a wireless network system 1 may include a plurality of wireless access points, and these wireless access points may be communicatively connected directly (that is, connected with each other without through other communication devices) or indirectly (that is, connected with each other through other communication devices) and may transmit various messages to each other. The wireless access points, also known as wireless base stations, may be used to connect wireless networks with wired networks (Ethernet). Therefore, these wireless access points may be further connected to one or more routers 15 and connected to the Internet 16 through the one or more routers 15. For example, in some embodiments of the present invention, the wireless network system 1 may comprise a first wireless access point 11 and a second wireless access point 12. The first wireless access point 11 may be communicatively connected with the second wireless access point 12, and the first wireless access point 11 and the second wireless access point 12 may transmit various messages to each other. In addition, the first wireless access point 11 and the second wireless access point 12 are connected to the router 15 and connected to the Internet 16 through the router 15. In the wireless network system 1, the first wireless access point 11 and the second wireless access point 12 have respectively obtained a configuration file from a cloud server via the Internet 16, and the configuration file at least comprises a same Group ID. Wireless access points that obtain the same Group ID can transmit various messages to each other.

The first wireless access point 11 and the second wireless access point 12 may each be implemented as one of various types of wireless access points, such as, but not limited to ceiling-mounted wireless access points, wall-mounted wireless access points, outdoor wireless access points, indoor wireless access points and the like. The router 15 may be implemented as one of various types of routers, such as, but not limited to: a core router, an edge router, a distribution router, a wireless router, a virtual router and the like.

Still referring to FIG. 1, when a mobile device D1 is within the signal coverage of the second wireless access point 12, the mobile device D1 may request for a connection from the second wireless access point 12, and the second wireless access point 12 may be configured to perform connection authentication for the mobile device D1. For example, when the mobile device D1 requests for a connection from the second wireless access point 12, the mobile device D1 may need to provide a connection password to the second wireless access point 12, and then the second wireless access point 12 verifies the connection password. If the connection password provided by the mobile device D1 is correct, then the second wireless access point 12 may allow the mobile device D1 to connect to the Internet 16 and store the connection authentication information D11 of the mobile device D1. On the contrary, if the connection password provided by the mobile device D1 is incorrect, then the second wireless access point 12 may prohibit the mobile device D1 from connecting to the Internet 16. The connection authentication information D11 of the mobile device D1 may include various information that can identify the mobile device D1, such as, but not limited to, Media Access Control Address (MAC Address). After completing the connection authentication of the mobile device D1, the second wireless access point 12 may be configured to provide the connection authentication information D11 of the mobile device D1 to the first wireless access point 11, so that the first wireless access point 11 and the second wireless access point 12 collectively store the connection authentication information D11 of the mobile device D1. After the first wireless access point 11 obtains and stores the connection authentication information D11 of the mobile device D1, the first wireless access point 11 will not need to perform the same connection authentication for the mobile device D1 again if the mobile device D1 roams from the second wireless access point 12 to the first wireless access point 11. Thus, the connection between the mobile device D1 and the first wireless access point 11 can be quickly established. The mobile device D1 may be one of various portable electronic devices that can establish connection with wireless access points, such as but not limited to: mobile phones, notebook computers, smart watches, or the like.

In some embodiments, the first wireless access point 11 and the second wireless access point 12 may be configured to remove the connection authentication information D11 of the mobile device D1 when a preset time period expires, thereby reducing the burden of storing information of the first wireless access point 11 and the second wireless access point 12. The preset time period may be, for example, but not limited to: 6 hours, 12 hours, 24 hours, 3 days, one week, one month or the like. In some embodiments, the first wireless access point 11 and the second wireless access point 12 may also be configured to remove the connection authentication information D11 of the mobile device D1 respectively when the respective preset time period expires.

In some embodiments, the second wireless access point 12 may perform the connection authentication for the mobile device D1 with a captive portal. The captive portal is a mechanism that can provide the mobile device D1 with temporary access to the Internet 16. When the mobile device D1 requests for a connection, the captive portal can force the mobile device D1 to present specific content to request the user of the mobile device D1 to input specific information, and the second wireless access point 12 will decide whether to allow the mobile device D1 to connect to the Internet 16 (that is, whether to allow the user to access the Internet 16) according to the information input by the user. Through the captive portal, the second wireless access point 12 may also set a connection survival time, thereby preventing the mobile device connected thereto from occupying the connection service and resources provided by the second wireless access point 12 for a long time.

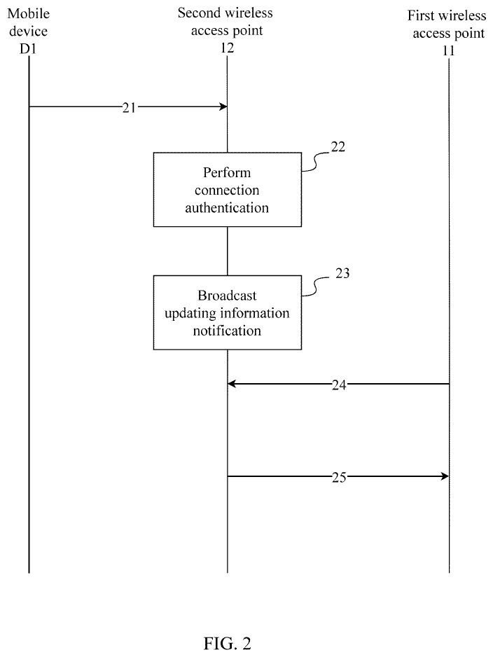

FIG. 2 illustrates a schematic view for how the wireless network system 1 implements the sharing of connection authentication information. Referring to FIG. 1 and FIG. 2, in some embodiments, when the mobile device D1 requests for a connection from the second wireless access point 12 (action 21), the second wireless access point 12 may be configured to perform connection authentication for the mobile device D1 (action 22). After completing the connection authentication of the mobile device D1, the second wireless access point 12 may be configured to broadcast an updating information notification (action 23) to inform other wireless access points (including the first wireless access point 11) that the second wireless access point 12 has the connection authentication information D11 of the mobile device D1. Other wireless access points (including the first wireless access point 11) may be configured to unicast an updating information request to the second wireless access point 12 (action 24) upon receiving the updating information notification, so as to request the connection authentication information D11 of the mobile device D1 from the second wireless access point 12. The second wireless access point 12 may be configured to unicast an updating information response to other wireless access points (including the first wireless access point 11) upon receiving the updating information request, wherein the updating information response includes the connection authentication information D11 of the mobile device D1 (action 25), so that other wireless access points (including the first wireless access point 11) and the second wireless access point 12 can collectively store the connection authentication information D11 of the mobile device D1. After other wireless access points (including the first wireless access point 11) obtain and store the connection authentication information D11 of the mobile device D1, these other wireless access points (including the first wireless access point 11) will not need to perform the connection authentication for the mobile device D1 again if the mobile device D1 roams from the second wireless access point 12 to these other wireless access points (including the first wireless access point 11), so that the speed of establishing connection between these other wireless access points (including the first wireless access point 11) and the mobile device D1 can be improved. The broadcasting of the updating information notification can simultaneously be transmitted to multiple other wireless access points (including the first wireless access point 11), while the unicast transmission combined with message encryption can improve the security of information transmission between these other wireless access points (including the first wireless access point 11) and the second wireless access point 12.

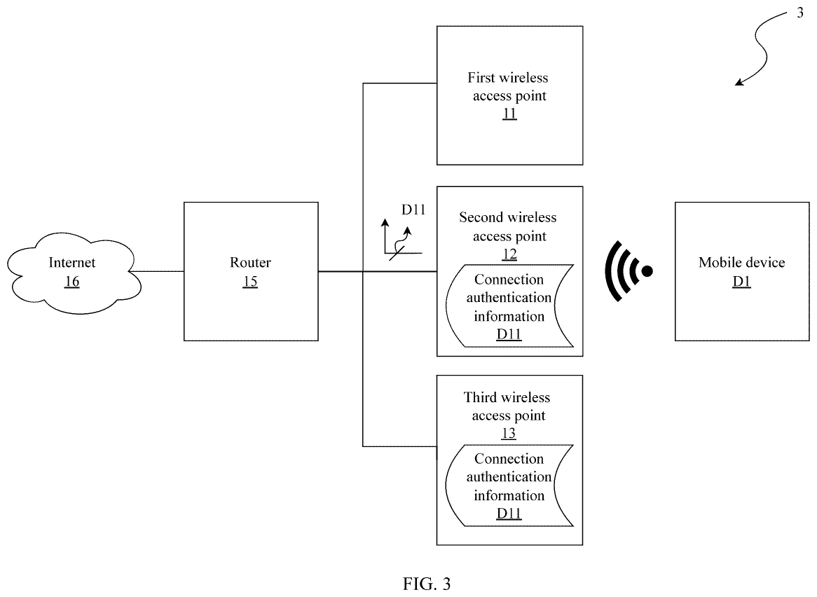

FIG. 3 illustrates a schematic view of another wireless network system according to the present invention. Referring to FIG. 3, in some embodiments of the present invention, like the wireless network system 1, a wireless network system 3 may comprise a first wireless access point 11 and a second wireless access point 12, and the first wireless access point 11 and the second wireless access point 12 may be communicatively connected directly or indirectly and can transmit various messages to each other. In the wireless network system 3, the first wireless access point 11 and the second wireless access point 12 have respectively obtained a configuration file from a cloud server via the Internet 16, and the configuration file at least comprises a same Group ID. Under the condition that the first wireless access point 11 and the second wireless access point 12 collectively store the connection authentication information D11 of the mobile device D1, if the first wireless access point 11 reboots, then the second wireless access point 12 may be configured to provide the connection authentication information D11 of the mobile device D1 to the first wireless access point 11 after the first wireless access point 11 reboots (or being restarted). Since the first wireless access point 11 may reset the information stored therein (including the connection authentication information D11 of the mobile device D1) after the first wireless access point 11 reboots, the second wireless access point 12 will provide the connection authentication information D11 of the mobile device D1 to the first wireless access point 11 again after the first wireless access point 11 reboots, which can avoid the problem of performing the connection authentication again due to the lack of the connection authentication information D11 in the first wireless access point 11 when the mobile device D1 roams from the second wireless access point 12 to the first wireless access point 11.

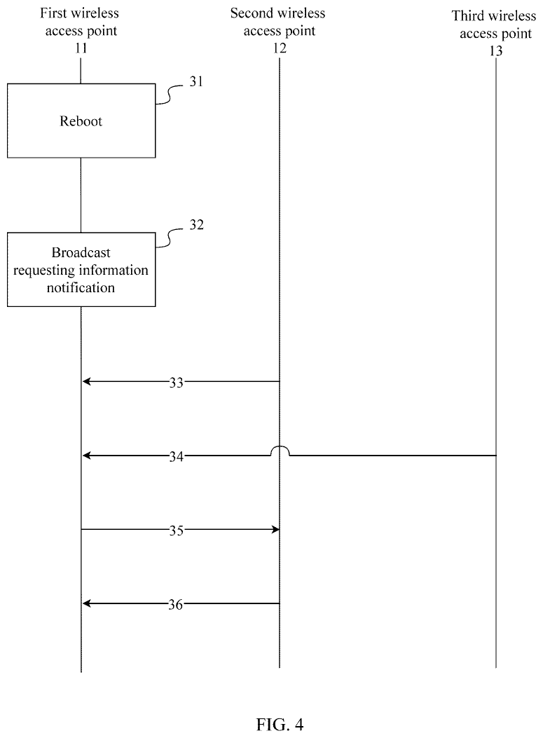

FIG. 4 illustrates a schematic view for how the wireless network system 3 implements the sharing of connection authentication information. Referring to FIG. 3 and FIG. 4, in some embodiments, the first wireless access point 11 may broadcast a requesting information notification (action 32) after it reboots (action 31) to inform other wireless access points (including the second wireless access point 12) that the first wireless access point 11 needs the connection authentication information D11 of the mobile device D1. Next, after receiving the requesting information notification, the second wireless access point 12 may unicast an offer notification to the first wireless access point (action 33) to inform the first wireless access point 11 that the second wireless access point 12 can provide the connection authentication information D11 of the mobile device D1. Then, after receiving the offer notification from the second wireless access point 12, the first wireless access point 11 may unicast an updating information request to the second wireless access point 12 (action 35), and request the connection authentication information D11 of the mobile device D1 from the second wireless access point 12. After receiving the updating information request, the second wireless access point 12 may unicast an updating information response to the first wireless access point 11 (action 36), wherein the updating information response includes the connection authentication information D11 of the mobile device D1, so that the first wireless access point 11 can continue to store the connection authentication information D11 of the mobile device D1 collectively with other wireless access points (including the second wireless access point 12) after it reboots (action 31). The broadcasting of the requesting information notification can simultaneously be transmitted to the multiple other wireless access points (including the second wireless access point 12) by the first wireless access point 11, while the unicast transmission combined with message encryption can improve the security of information transmission between other wireless access points (including the second wireless access point 12) and the first wireless access point 11.

In some other embodiments, it is assumed that the wireless network system 3 further comprises a third wireless access point 13, and the third wireless access point 13 is communicatively connected to the first wireless access point 11 and the second wireless access point 12, respectively. In addition, it is assumed that the third wireless access point 13 has also obtained the configuration file from the cloud server via the Internet 16 and obtained the same Group ID from the configuration file. In this case, after receiving the requesting information notification broadcasted by the first wireless access point 11, the third wireless access point 13 may also unicast an offer notification to the first wireless access point 11 (action 34) to inform the first wireless access point 11 that the third wireless access point 13 can provide the connection authentication information D11 of the mobile device D1. The first wireless access point 11 may decide whether to unicast an updating information request to the second wireless access point 12 or the third wireless access point 13 according to various connection selection mechanisms. For example, the first wireless access point 11 may make the decision according to the order in which the offer notifications are received. As shown in FIG. 4, if the time of the first wireless access point 11 receiving the offer notification from the second wireless access point 12 (i.e., action 33) is earlier then the time of the first wireless access point 11 receiving the offer notification from the third wireless access point 13, then the first wireless access point 11 may be configured to only unicast an updating information request to the second wireless access point 12 (i.e., action 35), thereby reducing unnecessary message transmission and reducing the resources occupied during information transmission among the wireless access points.

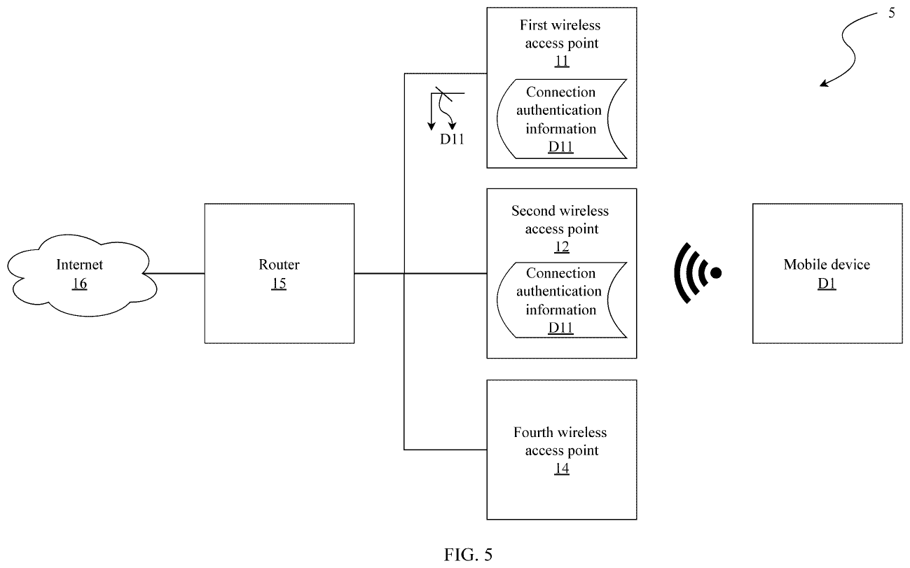

FIG. 5 illustrates a schematic view of yet another wireless network system according to the present invention. Referring to FIG. 5, in some embodiments of the present invention, like the wireless network system 1, a wireless network system 5 may comprise a first wireless access point 11 and a second wireless access point 12 which have established direct or indirect communication connection therebetween, and the first wireless access point 11 and the second wireless access point 12 may transmit various messages to each other. In the wireless network system 5, the first wireless access point 11 and the second wireless access point 12 have respectively obtained a configuration file from a cloud server via the Internet 16, and the configuration file at least comprises a same Group ID. The wireless network system 5 may further comprise a fourth wireless access point 14, which is newly added in the wireless network system 5 and thus has not yet obtained the configuration file. In this case, the fourth wireless access point 14 may first obtain the configuration file from the cloud server via the Internet 16 and obtain the same Group ID from the configuration file, and then attempt to establish communication connection with the first wireless access point 11 and/or the second wireless access point 12. When the fourth wireless access point 14 is communicatively connected to the first wireless access point 11 and/or the second wireless access point 12, the fourth wireless access point 14 may be configured to request the connection authentication information D11 of the mobile device D1 from the first wireless access point 11 and/or the second wireless access point 12, and the first wireless access point 11 and/or the second wireless access point 12 may be configured to provide the connection authentication information D11 of the mobile device D1 to the fourth wireless access point 14, thereby achieving the purpose of collectively storing the connection authentication information D11 of the mobile device D1. In this way, when the mobile device D1 roams from the first wireless access point 11 or the second wireless access point 12 to the fourth wireless access point 14, it is unnecessary for the fourth wireless access point 14 to perform the connection authentication for the mobile device D1 again, because the fourth wireless access point 14 has stored the connection authentication information D11 of the mobile device D1.

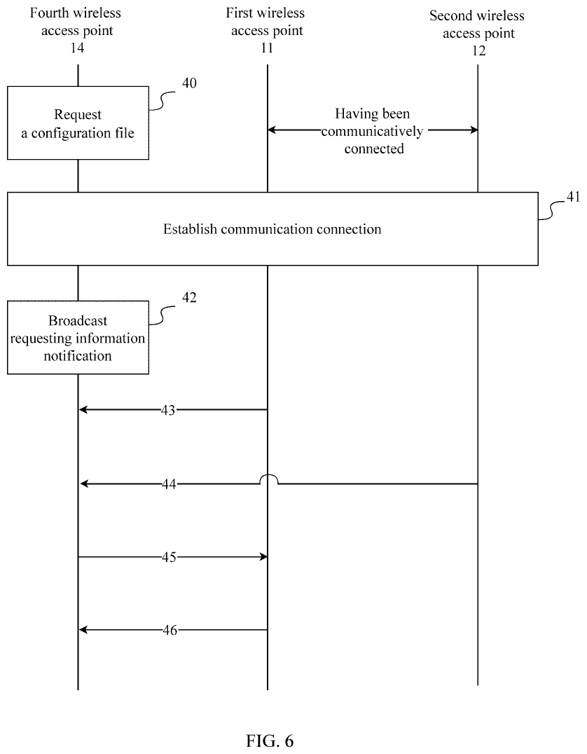

FIG. 6 illustrates a schematic view for how the wireless network system 5 implements the sharing of connection authentication information. Referring to FIG. 5 and FIG. 6, in some embodiments, in the case where the first wireless access point 11 and the second wireless access point 12 have established communication connection, the fourth wireless access point 14 may first obtain the configuration file from the cloud server via the Internet 16 (action 40), and then attempt to establish communication connection with the first wireless access point 11 and/or the second wireless access point 12. Once the fourth wireless access point 14 has established communication connection with the first wireless access point 11 and the second wireless access point 12 (action 41), the fourth wireless access point 14 may be configured to broadcast a requesting information notification (action 42) to request the connection authentication information D11 of the mobile device D1 from the first wireless access point 11 and the second wireless access point 12. Next, after receiving the requesting information notification, the first wireless access point 11 and the second wireless access point 12 may respectively unicast an offer notification to the fourth wireless access point 14 (actions 43 and 44). The fourth wireless access point 14 may decide whether to unicast an updating information request to the first wireless access point 11 or the second wireless access point 12 according to various connection selection mechanisms. For example, the fourth wireless access point 11 may make the decision according to the order in which the offer notifications are received. As shown in FIG. 6, if the time of the fourth wireless access point 14 receiving the offer notification from the first wireless access point 11 (i.e., the action 43) is earlier then the time of the fourth wireless access point 14 receiving the offer notification from the second wireless access point 12 (i.e., the action 44), then the fourth wireless access point 14 may only unicast an updating information request to the first wireless access point 11 (action 45), thereby reducing unnecessary message transmission and reducing the resources occupied during the information transmission among the wireless access points. Finally, after receiving the updating information request, the first wireless access point 11 may unicast an updating information response to the fourth wireless access point 14 (action 46), wherein the updating information response includes the connection authentication information D11 of the mobile device. The broadcasting of the requesting information notification can be transmitted at the same time to multiple other wireless access points (including the first wireless access point 11 and the second wireless access point 12) by the fourth wireless access point 14, while the unicast transmission combined with message encryption can improve the security of information transmission between the first wireless access point 11 or the second wireless access point 12 and the fourth wireless access point 14.

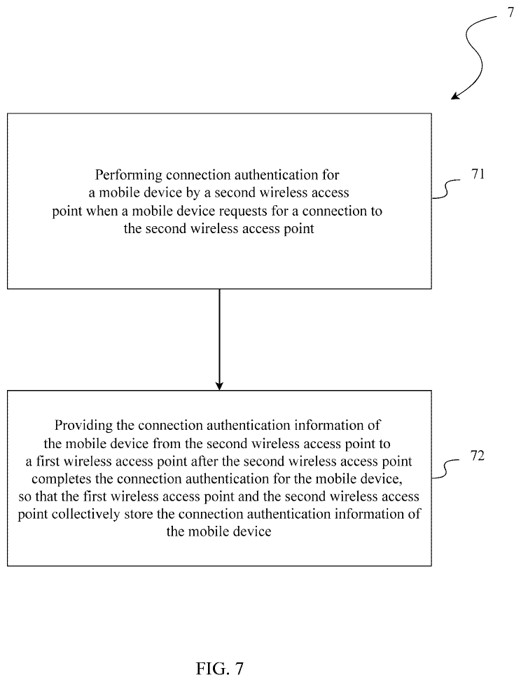

FIG. 7 illustrates a schematic view of a method for sharing connection authentication information according to the present invention. Referring to FIG. 7, in some embodiments of the present invention, the method 7 for sharing connection authentication information may be executed by a wireless network system (such as but not limited to the above-mentioned wireless network system 1, 3 or 5), the wireless network system may comprise a first wireless access point and a second wireless access point communicatively connected to the first wireless access point, and the method 7 for sharing connection authentication information may comprise the following steps: performing connection authentication for a mobile device by the second wireless access point when the mobile device requests for a connection to the second wireless access point (step 71); and providing the connection authentication information of the mobile device from the second wireless access point to the first wireless access point after the second wireless access point completes the connection authentication for the mobile device, so that the first wireless access point and the second wireless access point collectively store the connection authentication information of the mobile device (step 72).

The broadcasting of the updating information notification can be transmitted at the same time to multiple other wireless access points (including the first wireless access point) by the second wireless access point, while the unicast transmission combined with message encryption can improve the security of information transmission between other wireless access points (including the first wireless access point) and the second wireless access point. Therefore, in some embodiments of the method 7 for sharing connection authentication information, the method 7 for sharing connection authentication information may further comprise: broadcasting an updating information notification by the second wireless access point after the second wireless access point completes the connection authentication for the mobile device; unicasting an updating information request from the first wireless access point to the second wireless access point upon the first wireless access point receiving the updating information notification; and unicasting an updating information response from the second wireless access point to the first wireless access point upon the second wireless access point receiving the updating information request, wherein the updating information response includes the connection authentication information of the mobile device.

Since the first wireless access point may reset the information stored therein (including the connection authentication information of the mobile device) after the first wireless access point reboots, the second wireless access point will provide the connection authentication information of the mobile device to the first wireless access point again after the first wireless access point reboots, which can avoid the problem of performing the connection authentication again due to the lack of connection authentication information in the first wireless access point when the mobile device roams from the second wireless access point to the first wireless access point. Therefore, in some embodiments of the method 7 for sharing connection authentication information, the method 7 for sharing connection authentication information may further comprise: providing the connection authentication information of the mobile device from the second wireless access point to the first wireless access point after the first wireless access point reboots.

The broadcasting of the updating information notification can be transmitted at the same time to multiple other wireless access points (including the second wireless access point) by the first wireless access point, while the unicast transmission combined with message encryption can improve the security of information transmission between other wireless access points (including the second wireless access point) and the first wireless access point. Therefore, in some embodiments of the method 7 for sharing connection authentication information, the method 7 for sharing connection authentication information may further comprise: broadcasting a requesting information notification by the first wireless access point after the first wireless access point reboots; unicasting an offer notification from the second wireless access point to the first wireless access point upon the second wireless access point receiving the requesting information notification; unicasting an updating information request from the first wireless access point to the second wireless access point upon the first wireless access point receiving the offer notification; and unicasting an updating information response from the second wireless access point to the first wireless access point upon the second wireless access point receiving the updating information request, wherein the updating information response includes the connection authentication information of the mobile device.

It is assumed that the wireless network system further comprises a third wireless access point, and the third wireless access point is communicatively connected to the first wireless access point and the second wireless access point respectively. In this case, the third wireless access point may also unicast an offer notification to the first wireless access point upon receiving the requesting information notification broadcasted by the first wireless access point, so as to inform the first wireless access point that the third wireless access point can provide the connection authentication information of the mobile device. The first wireless access point may decide whether to unicast an updating information request to the second wireless access point or the third wireless access point according to various connection selection mechanisms. For example, the first wireless access point may make the decision according to the order in which the offer notifications are received. If the time of the first wireless access point receiving the offer notification from the second wireless access point is earlier then the time of the first wireless access point receiving the offer notification from the third wireless access point, then the first wireless access point may be configured to only unicast an updating information request to the second wireless access point, thereby reducing unnecessary message transmission and reducing the resources occupied during information transmission among the wireless access points. Therefore, in some embodiments of the method 7 for sharing connection authentication information, the method 7 for sharing connection authentication information may further comprise: unicasting an offer notification from the third wireless access point to the first wireless access point upon the third wireless access point receiving the requesting information notification, wherein the first wireless access point receives the offer notification from the second wireless access point before receiving the offer notification from the third wireless access point.

The first wireless access point and the second wireless access point may remove the connection authentication information of the mobile device when a preset time period expires, so that the burden of storing information of the first wireless access point and the second wireless access point can be reduced. Therefore, in some embodiments of the method 7 for sharing connection authentication information, the method 7 for sharing connection authentication information may further comprise: removing the connection authentication information of the mobile device by the first wireless access point and the second wireless access point when a preset time period expires.

The captive portal is a mechanism that can provide the mobile device with temporary access to the Internet. When the mobile device requests for a connection, the captive portal can force the mobile device to present specific content to request the user of the mobile device to input specific information, and the second wireless access point will decide whether to allow the mobile device to connect to the Internet (that is, whether to allow the user to access the Internet) according to the information input by the user. Through the captive portal, the second wireless access point may also set a connection survival time, thereby preventing the mobile device connected thereto from occupying the connection service and resources provided by the second wireless access point for a long time. Therefore, in some embodiments of the method 7 for sharing connection authentication information, the second wireless access point may perform the connection authentication for the mobile device with the captive portal.

It is assumed that the wireless network system further comprises a fourth wireless access point, and the fourth wireless access point is communicatively connected to the first wireless access point and the second wireless access point respectively. When the mobile device roams from the first wireless access point or the second wireless access point to the fourth wireless access point, the fourth wireless access point does not need to perform the connection authentication for the mobile device again if the fourth wireless access point has stored the connection authentication information of the mobile device. Therefore, in some embodiments of the method 7 for sharing connection authentication information, the method 7 for sharing connection authentication information may further comprise: requesting the connection authentication information of the mobile device from the first wireless access point and the second wireless access point by the fourth wireless access point when the fourth wireless access point is communicatively connected to the first wireless access point and the second wireless access point.

The broadcasting of the requesting information notification can be transmitted at the same time to multiple other wireless access points (including the first wireless access point and the second wireless access point) by the fourth wireless access point, while the unicast transmission combined with message encryption can improve the security of information transmission between the first wireless access point or the second wireless access point and the fourth wireless access point. In addition, the fourth wireless access point may also decide whether to unicast an updating information request to the first wireless access point or the second wireless access point according to various connection selection mechanisms. For example, the fourth wireless access point may make the decision according to the order in which the offer notifications are received. If the time of the fourth wireless access point receiving the offer notification from the first wireless access point is earlier then the time of the fourth wireless access point receiving the offer notification from the second wireless access point, then the fourth wireless access point may only unicast an updating information request to the first wireless access point, thereby reducing unnecessary message transmission and reducing the resources occupied during information transmission among the wireless access points. Therefore, in some embodiments of the method 7 for sharing connection authentication information, the method 7 for sharing connection authentication information may further comprise: broadcasting a requesting information notification by the fourth wireless access point when the fourth wireless access point is communicatively connected to the first wireless access point and the second wireless access point; unicasting an offer notification from each of the first wireless access point and the second wireless access point to the fourth wireless access point upon each of the first wireless access point and the second wireless access point receiving the requesting information notification; unicasting an updating information request from the fourth wireless access point to the first wireless access point upon the fourth wireless access point receiving the offer notification from the first wireless access point, wherein the fourth wireless access point receives the offer notification from the first wireless access point before receiving the offer notification from the second wireless access point; and unicasting an updating information response from the first wireless access point to the fourth wireless access point upon the first wireless access point receiving the updating information request, wherein the updating information response includes the connection authentication information of the mobile device.

Each embodiment of the method 7 for sharing connection authentication information basically at least corresponds to a certain embodiment of the wireless network systems 1, 3 and 5. Therefore, all the corresponding embodiments of the method 7 for sharing connection authentication information can be fully understood and realized by those of ordinary skill in the art simply with reference to the above description of the wireless network systems 1, 3 and 5, even though not all the embodiments of the method 7 for sharing connection authentication information are described in detail above.

The above embodiments are only examples for illustrating the embodiments of the present invention, and are not intended to limit the scope claimed in the present invention. Any other embodiments produced by modifying, changing, adjusting and integrating the above-mentioned embodiments shall all be included in the scope claimed in the present invention as long as they are not difficult for those of ordinary skill in the art to contemplate. The scope claimed in the present invention shall be governed by the claims.

What is claimed is:

1. A wireless network system comprising:
a first wireless access point; and
a second wireless access point communicatively connected to the first wireless access point, being configured to:
perform connection authentication for a mobile device when the mobile device requests for a connection; and
provide connection authentication information of the mobile device to the first wireless access point after completing the connection authentication for the mobile device, so that the first wireless access point and the second wireless access point collectively store the connection authentication information of the mobile device.

2. The wireless network system of claim 1, wherein:
the second wireless access point is further configured to broadcast an updating information notification after completing the connection authentication for the mobile device;
the first wireless access point is further configured to unicast an updating information request to the second wireless access point upon receiving the updating information notification; and
the second wireless access point is further configured to unicast an updating information response to the first wireless access point upon receiving the updating information request, wherein the updating information response includes the connection authentication information of the mobile device.

3. The wireless network system of claim 1, wherein:
the second wireless access point is further configured to provide the connection authentication information of the mobile device to the first wireless access point after the first wireless access point reboots.

4. The wireless network system of claim 3, wherein:
the first wireless access point is further configured to broadcast a requesting information notification after the first wireless access point reboots;
the second wireless access point is further configured to unicast an offer notification to the first wireless access point upon receiving the requesting information notification;
the first wireless access point is further configured to unicast an updating information request to the second wireless access point upon receiving the offer notification; and
the second wireless access point is further configured to unicast an updating information response to the first wireless access point upon receiving the updating information request, wherein the updating information response includes the connection authentication information of the mobile device.

5. The wireless network system of claim 4, further comprising a third wireless access point, wherein:
the third wireless access point is communicatively connected to the first wireless access point and the second wireless access point, and is configured to unicast an offer notification to the first wireless access point upon receiving the requesting information notification; and
the time of the first wireless access point receiving the offer notification from the second wireless access point is earlier than the time of the first wireless access point receiving the offer notification from the third wireless access point.

6. The wireless network system of claim 1, wherein the first wireless access point and the second wireless access point are further configured to remove the connection authentication information of the mobile device when a preset time period expires.

7. The wireless network system of claim 1, wherein the second wireless access point is further configured to perform the connection authentication for the mobile device with a captive portal.

8. The wireless network system of claim 1, further comprising a fourth wireless access point, wherein:
the fourth wireless access point is configured to request the connection authentication information of the mobile device from the first wireless access point and the second wireless access point when the fourth wireless access point is communicatively connected to the first wireless access point and the second wireless access point.

9. The wireless network system of claim 8, wherein:
the fourth wireless access point is further configured to broadcast a requesting information notification when the fourth wireless access point is communicatively connected to the first wireless access point and the second wireless access point;
each of the first wireless access point and the second wireless access point is further configured to unicast an offer notification to the fourth wireless access point upon receiving the requesting information notification;
the fourth wireless access point is further configured to unicast an updating information request to the first wireless access point upon receiving the offer notification from the first wireless access point, wherein the time of the fourth wireless access point receiving the offer notification from the first wireless access point is earlier than the time of the fourth wireless access point receiving the offer notification from the second wireless access point; and
the first wireless access point is further configured to unicast an updating information response to the fourth wireless access point upon receiving the updating information request, wherein the updating information response includes the connection authentication information of the mobile device.

10. A method for sharing connection authentication information in a wireless network system comprising a first wireless access point and a second wireless access point communicatively connected to the first wireless access point, comprising:
performing connection authentication for a mobile device by the second wireless access point when the mobile device requests for a connection to the second wireless access point; and
providing the connection authentication information of the mobile device from the second wireless access point to the first wireless access point after the second wireless access point completes the connection authentication for the mobile device, so that the first wireless access point and the second wireless access point collectively store the connection authentication information of the mobile device.

11. The method for sharing connection authentication information of claim 10, further comprising:
broadcasting an updating information notification by the second wireless access point after the second wireless access point completes the connection authentication for the mobile device;
unicasting an updating information request from the first wireless access point to the second wireless access point upon the first wireless access point receiving the updating information notification; and
unicasting an updating information response from the second wireless access point to the first wireless access point upon the second wireless access point receiving the updating information request, wherein the updating information response includes the connection authentication information of the mobile device.

12. The method for sharing connection authentication information of claim 10, further comprising:
providing the connection authentication information of the mobile device from the second wireless access point to the first wireless access point after the first wireless access point reboots.

13. The method for sharing connection authentication information of claim 12, further comprising:
broadcasting a requesting information notification by the first wireless access point after the first wireless access point reboots;
unicasting an offer notification from the second wireless access point to the first wireless access point upon the second wireless access point receiving the requesting information notification;
unicasting an updating information request from the first wireless access point to the second wireless access point upon the first wireless access point receiving the offer notification; and
unicasting an updating information response from the second wireless access point to the first wireless access point upon the second wireless access point receiving the updating information request, wherein the updating information response includes the connection authentication information of the mobile device.

14. The method for sharing connection authentication information of claim 13, wherein the wireless network system further comprises a third wireless access point, and the method for sharing connection authentication information further comprises:
unicasting an offer notification from the third wireless access point to the first wireless access point upon the third wireless access point receiving the requesting information notification, wherein the time of the first wireless access point receiving the offer notification from the second wireless access point is earlier then the time of the first wireless access point receiving the offer notification from the third wireless access point.

15. The method for sharing connection authentication information of claim 10, further comprising:
removing the connection authentication information of the mobile device by the first wireless access point and the second wireless access point when a preset time period expires.

16. The method for sharing connection authentication information of claim 10, wherein the second wireless access point performs the connection authentication for the mobile device with a captive portal.

17. The method for sharing connection authentication information of claim 10, wherein the wireless network system further comprises a fourth wireless access point, and the method for sharing connection authentication information further comprises:
requesting the connection authentication information of the mobile device from the first wireless access point and the second wireless access point by the fourth wireless access point when the fourth wireless access point is communicatively connected to the first wireless access point and the second wireless access point.

18. The method for sharing connection authentication information of claim 17, further comprising:
broadcasting a requesting information notification by the fourth wireless access point when the fourth wireless access point is communicatively connected to the first wireless access point and the second wireless access point;
unicasting an offer notification from each of the first wireless access point and the second wireless access point to the fourth wireless access point upon each of the first wireless access point and the second wireless access point receiving the requesting information notification;
unicasting an updating information request from the fourth wireless access point to the first wireless access point upon the fourth wireless access point receiving the offer notification from the first wireless access point, wherein the time of the fourth wireless access point receiving the offer notification from the first wireless access point is earlier then the time of the fourth wireless access point receiving the offer notification from the second wireless access point; and
unicasting an updating information response from the first wireless access point to the fourth wireless access point upon the first wireless access point receiving the updating information request, wherein the updating information response includes the connection authentication information of the mobile device.
